(19) United States
(12) Patent Application Publication
(10) Pub. No.: US 2022/0210020 A1
(43) Pub. Date: Jun. 30, 2022

(54) Smart Meter For Monitoring And Controlling Internet Usage

(71) Applicant: Hughes Network Systems, LLC, Germantown, MD (US)

(72) Inventor: Douglas Merrill DILLON, Rockville, MD (US)

(73) Assignee: Hughes Network Systems, LLC, Germantown, MD (US)

(21) Appl. No.: 17/139,686

(22) Filed: Dec. 31, 2020

(51) Int. Cl. H04L 12/24; H04L 12/26; H04L 29/06; H04L 12/801

(52) U.S. Cl. CPC H04L 41/0896; H04L 47/10; H04L 63/0823; H04L 43/0876

(57) ABSTRACT

Systems and methods for implementing a network metering system which includes a classifier which measures network usage by device, application, device and application and time of day, where the device is given an end-user identifiable device type name based on characteristics of network traffic the device carried, and at least in part based on the upstream domain names the device has interacted with; and a traffic shaper that allows device network traffic and application network traffic to be individually controlled with control settings, including blocking, blocking by time of day, blocking when usage limits are reached, rate limiting and rate limiting by time of day.

### BACKGROUND

Wireless internet broadband services, such as those provided by geosynchronous satellite, sometimes referred to as High-Thruput-Satellite or HTS, and cellular telephony services (here-in-after referred to as LTE) differ from wired broadband Internet access in that the capacity of wireless networks is typically much less than that of a wired broadband network. The result of this is that the amount of usage (measured in units of, perhaps, GB/month) cost-effectively available to a user is less than the usage a user would consume were capacity limits not a concern. An example of this is a Cell-Phone service plan with a limit of 4 GB/month while a cable modem service might have a limit which is 1000 times larger.

Metered internet access is internet access where the cost to the user depends on the amount of data transferred. Additionally, in metered internet access, performance to the end-user may also be reduced by the service provider as usage exceeds various thresholds. Metered internet access is the pre-dominant form of service offered by HTS and LTE Internet Service Providers (ISPs) to consumers.

Typical home networks are evolving from having a single PC accessing the Internet to having a growing number of Local Area Network (LAN) attached devices (also known as LAN hosts) accessing the internet via a router with a LAN interface and a Wide Area Network (WAN) interface. Many of these LAN devices generate internet usage without the direction of human users for software upgrades, status reporting, cloud-based processing of local data, etc. To promote the shifting of traffic away from peak usage times of the day and week, some metered ISP provides non-peak times of the week where usage is either not applied to monthly usage or is billed at a lower rate.

A Software Defined Wide Area Network (SD-WAN) is a network that allows software defined policies to be applied on a per-application and per-device basis to the selection of a WAN internet access connection to be used to carry that traffic. SD-WAN technology may use one or more metered ISP connections.

### SUMMARY

Hence there is a need for a system and method to empower end-users to understand and control the usage over metered internet access connections. Implementations of the smart meter described herein provide for network usage measurement by time of day, device and application. In addition, implementations of the system and method include offering advertisements for alternative applications, devices and services to those in the user's network to reduce the usage consumed by the user's existing applications, devices and services. Further, the usage information is made available to the end-user in a way that allows the user to easily identify the heavier users of limited metered capacity, and how the user is doing compared to monthly limits. The smart meter may further allow selected traffic to be rate-limited or redirected to non-peak times. The smart meter may also provide the ability to traffic shape and control the usage by device/application and time of day.

This Summary identifies example features and aspects and is not an exclusive or exhaustive description of the disclosed subject matter. Whether features or aspects are included in or omitted from this Summary is not intended as indicative of relative importance of such features. Additional features and aspects are described, and others will become apparent to persons skilled in the art upon reading the following detailed description and viewing the drawings that form a part thereof.

An example of disclosed methods can include method for metering network usage and recommended alternatives for reducing usage, the method including measuring network usage of network traffic through a customer premise equipment (CPE) router over a metered network by device and application; receive traffic shaper control settings; controlling network traffic usage by device and application according to the traffic shaper control settings; evaluating current devices and current applications and comparing to a recommendations database with alternatives for devices and applications; selecting at least one alternative from the recommendations database which will provide expected significant usage savings; presenting the at least one alternative to the end-user with benefits of the at least one alternative shown in terms of the amount of bandwidth savings or fraction of a metered WAN's usage limit that is saved; and providing a way for the end-user to order an alternative device or alternative application corresponding to the at least one alternative.

An example of disclosed methods can include a method for metering network usage, the method including measuring network usage of network traffic through a customer premise equipment router over a metered network by device, application and time; receive traffic shaper control setting; and individually control network traffic by device and application and time according to the traffic shaper control settings.

An example of disclosed systems can include a network metering system which includes a classifier which measures network usage by device, application, device and application and time of day, where the device is given an end-user identifiable device type name based on characteristics of network traffic the device carried, and at least in part based on the upstream domain names the device has interacted with; and a traffic shaper that allows device network traffic and application network traffic to be individually controlled with control settings, including blocking, blocking by time of day, blocking when usage limits are reached, rate limiting and rate limiting by time of day.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 illustrates a high-level block diagram of a system for monitoring and controlling internet usage.

FIG. 2 illustrate a high-level block diagram of a customer premise equipment (CPE) router with a smart meter.

FIG. 3A illustrates upstream packet flow through the customer premise equipment router.

FIG. 3B illustrates downstream packet flow through the customer premise equipment router.

FIG. 4 illustrates a high-level block diagram of a classifier for monitoring internet usage.

FIG. 5 illustrates a flow diagram of a process or method for the packet processors to process upstream and downstream packets in the upstream packet processor.

FIG. 6 illustrates a flow diagram of a process or method for monitoring and controlling internet usage in accordance with this disclosure.

FIG. 7A illustrates a high-level block diagram of an alternative system for monitoring and controlling internet usage.

FIG. 7B illustrates a high-level block diagram of another alternative system for monitoring and controlling internet usage.

FIG. 7C illustrates a high-level block diagram of another alternative system for monitoring and controlling internet usage.

FIG. 8 illustrates a block diagram showing an example of CPE router hardware upon which aspects of this disclosure may be implemented.

FIG. 9 illustrates a block diagram showing an example computer system upon which aspects of this disclosure may be implemented.

### DETAILED DESCRIPTION

In the following detailed description, numerous specific details are set forth by way of examples to provide a thorough understanding of the disclosed subject matter. It may become apparent to persons of ordinary skill in the art, though, upon reading this disclosure, that one or more disclosed aspects may be practiced without such details. In addition, description of various example implementations according to this disclosure may include referencing of or to one or more known techniques or operations, and such referencing can be at relatively high-level, to avoid obscuring of various concepts, aspects and features thereof with details not particular to and not necessary for fully understanding the present disclosure.

This disclosure describes systems and methods for implementing a network metering system that empowers end-users to understand and control their network bandwidth usage over a metered internet access connection. Implementations of the smart meter described herein provide for usage measurement by time of day, device and application. Further, the usage information is made available to the end-user in a way that allows the user to easily identify the heavier users of limited metered capacity, and how the user is doing compared to monthly limits. The smart meter may further allow selected traffic to be rate-limited or redirected to non-peak times. The smart meter may also provide the ability to traffic shape and control the usage by device/application and time of day.

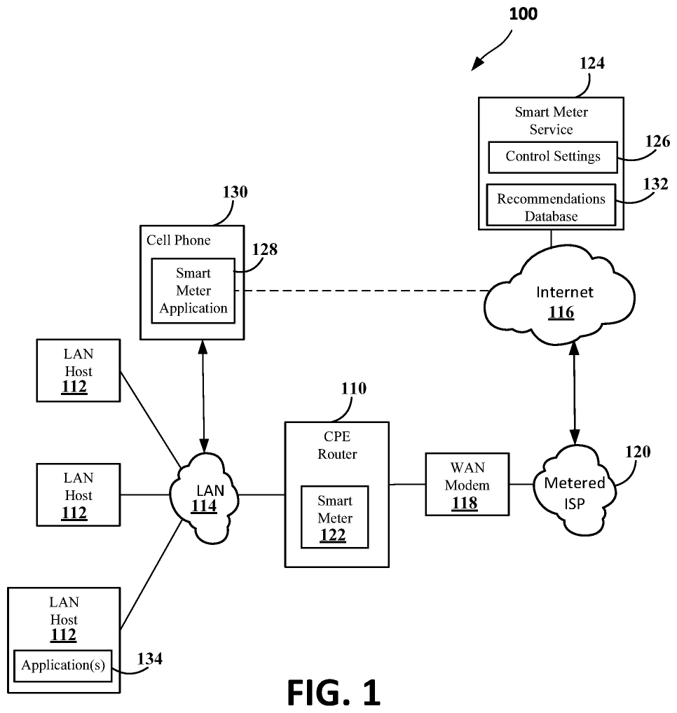

FIG. 1 illustrates a high-level block diagram of a system 100 for monitoring and controlling internet usage. A customer premise equipment (CPE) router 110 provides internet access for local area network (LAN) hosts 112 over a LAN 114. Where a LAN host 112 may also be referred to in this document as a LAN device (or device) or and where a device may host at any given time one or more applications 134. The CPE router 110 communicates with the internet 116 via a wide area network (WAN) modem 118. The WAN modem 118 provides public internet connectivity via a metered internet service provider (ISP) 120. A metered internet ISP is one where the user is billed depending on the amount of data transferred or bandwidth performance is reduced to the user as usage exceeds one or more thresholds. The CPE router 110 includes a smart meter 122 capable of monitoring and traffic shaping WAN traffic carried by the CPE router on behalf of LAN hosts as described herein. The smart meter 122 may provide summary usage information to a smart meter service 124 on the public internet 116. The smart meter service 124 may include traffic shaper control setting, or control settings 126 for controlling functionality of the smart meter 122 as described further herein.

The system 100 may further include a smart meter application 128 capable of running on a cell-phone 130 or other device with internet access such as a tablet with a web browser interface. The smart meter application 128 interacts with the smart meter service 124 to obtain usage and other information from the service and allow the user to set traffic shaping options in the control settings 126 which are relayed by the service 124 to the smart meter 122 in the CPE router 110. The smart meter application 128 may also offer for sale alternative applications, devices and services as described below. The cell phone 130 with the smart meter application 128 is shown in the figure as having access to the LAN 114 and obtaining access thereby to the smart meter service 124 but may also have access to the smart meter service 124 via the public internet 116 independently of the CPE router 110 as represented by the dashed line to the internet 116. The system 100 solves the technical problem of LAN hosts 112 being able to use network bandwidth over the metered IP 120 without control of the end-user. The system 100 provides the technical solution of a customer premise router 110 with a smart meter 122 that can be controlled by the end-user via control settings 126 as described herein.

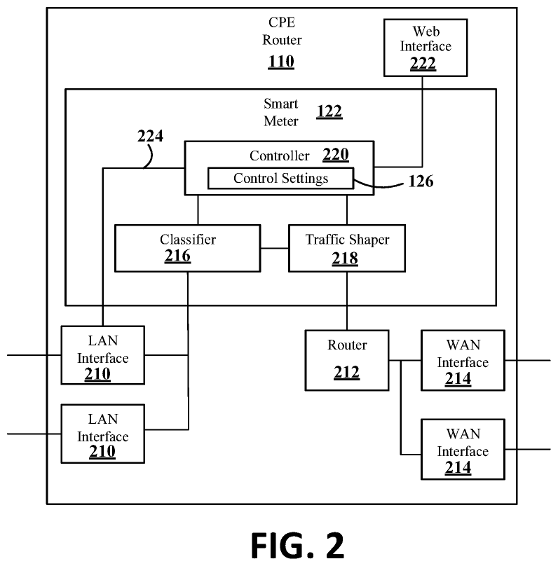

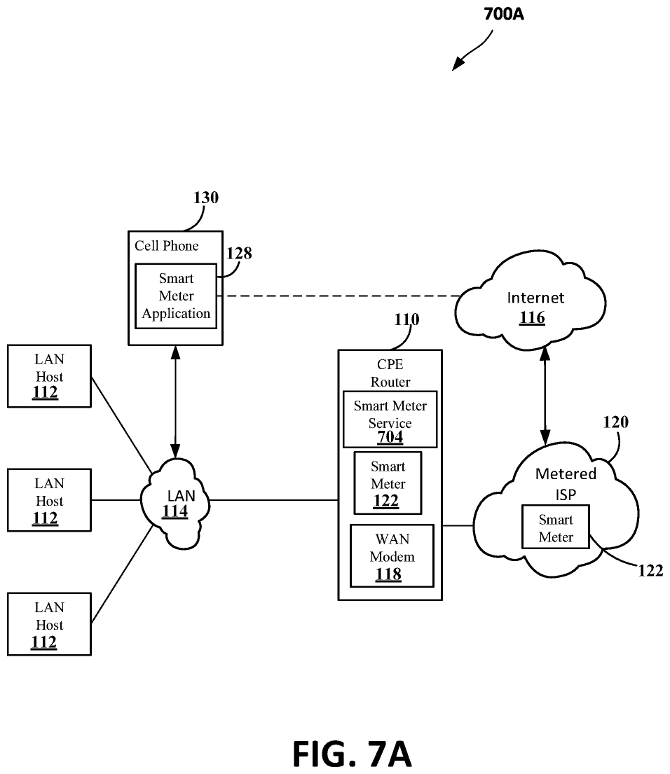

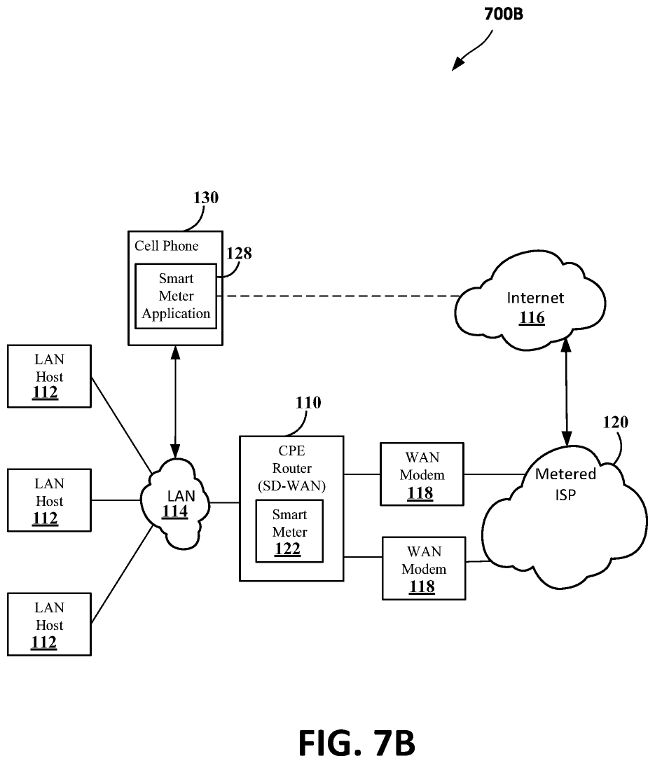

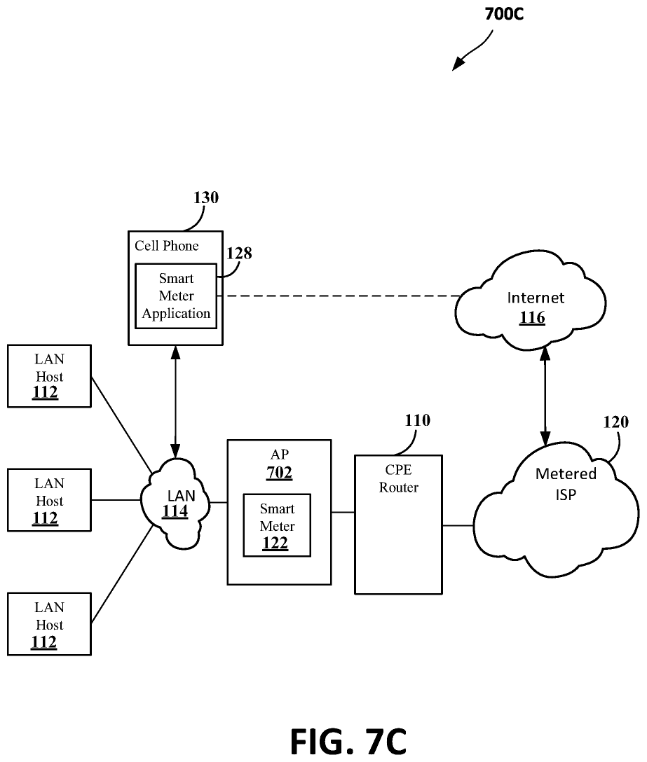

FIG. 2 illustrate a high-level block diagram of the CPE router 110 with a smart meter 122 introduced above. The CPE router 110 has one or more wired or wireless LAN interfaces 210 and at least one WAN interface 214. Alternatively, in an SD-WAN configuration, the CPE router 110 may have multiple WAN interfaces to multiple WAN connections as shown in FIG. 7B and described below. The CPE router 110 further includes a router block 212 with routing functionality that allows LAN hosts 112 to send packets to the public internet 116 and receive packets from the public internet 116 via the WAN modem 118 and metered ISP 120 as shown in FIG. 1. The router block 212 may include standard router features such as providing DHCP server functionality that provides LAN Hosts with IP addresses, network address translation that allows multiple LAN hosts to communicate with the internet sharing a single IP address, etc. The smart meter 122 includes a classifier 216 and a traffic shaper 218 which operate between the LAN interface 210 and the router block 212. The classifier 216 performs device classification, monitors application usage, and performs application and device control via the traffic shaper as described further below. The CPE router 110 also includes a controller 220 with control setting 222. The controller 220 receives usage information from the classifier 216 and forwards it to the smart meter service 124 and receives configuration information including traffic shaper control settings 126 from the smart meter service 124 and forwards it to the traffic shaper 218. The LAN interface 210 may also have a network connection 224 to the controller 220 to pass the control settings 126 to the controller 220 from the smart meter application 128. The smart meter 122 further solves the technical problem of LAN hosts 112 being able to use network bandwidth over the metered IP 120 without control of the end-user by providing the technical solution of a classifier 216 and traffic shaper 218 controlled by the controller 220 using the control settings 126.

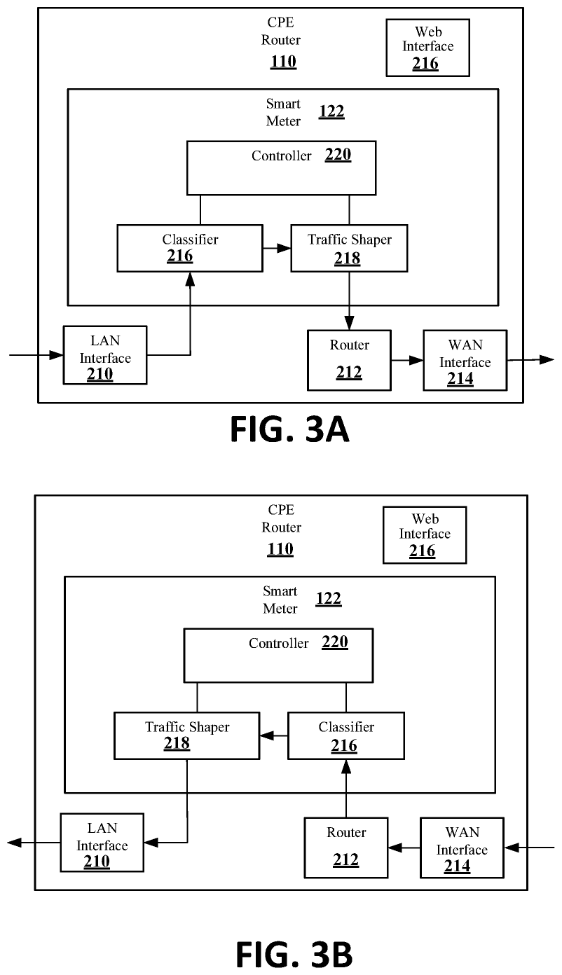

FIG. 3A illustrates upstream packet flow through the CPE router 110 where the arrows between the blocks indicated the direction of the packet flow with arrows associated with upstream flow. The LAN interface 210 receives upstream packets from the LAN hosts (112 in FIG. 1) off the LAN (114 FIG. 1) and forwards them to the smart meter classifier 216. The smart meter classifier 216 identifies each packet's IP flow (based on its upstream and downstream IP addresses and, if available, port numbers) and gathers stats about the IP flow and tags the packet with its IP flow's classification and passes the packet to the traffic shaper 218. The traffic shaper 218, based on its configuration and how the IP flow is tagged, determines whether the packet should be dropped or forwarded and forwards the packet to the router block 212 when forwarding is determined. The router block 212 processes forwarded packets and passes them to the WAN interface 114 for transmission across the metered ISP (120 FIG. 1) and then to the internet 116 (FIG. 1). Occasionally a packet is sent from the controller 220 to the smart meter service 124. The CPE router 110 passes the packet from the controller 220 thru the router's own protocol stack to the WAN modem 118. This is not shown in the figures.

FIG. 3B illustrates downstream packet flow through the CPE router 110. The WAN interface 114 receives downstream packets from the WAN modem (118 FIG. 1) off the internet 116 (116 FIG. 1) via the metered ISP 120 (FIG. 1) and forwards them to the router block 212. The router block 212 performs its routing functionality and forwards the packet to the classifier 216. The classifier 216 identifies each packet's IP flow (based on its upstream and downstream IP addresses and, if available, port numbers) and gathers stats about the IP flow and tags the packet with an IP flow classification and forwards the packet to the traffic shaper 218. The traffic shaper 218, based on its configuration and how the packet is tagged, determines whether the packet should be dropped or forwarded and forwards the packet to the LAN interface 210 when forwarding is determined. The traffic shaper may drop a packet because the device or application is blocked from communicating by the Controller 220 settings. Nearly all WAN communication is bidirectional and dropping downstream packets will quickly cause the source of those packets to cease or drastically reduce their transmission. Furthermore, most transport protocols treat packet loss as an indication of congestion. The traffic shaper is thus able to rate-limit a specific IP flow by inducing occasional packet loss which the application treats as an indication of congestion and thus an indication of the need to slow-down. The random-early drop technique is an example of using dropped packets to slow down an application. Forwarded packets are passed thru the LAN 210 interface for transmission across the LAN to one of the LAN hosts 112. Occasionally a packet is destined to the controller 220 (when it is interacting with the smart meter service) and the CPE router 110 passes the packet thru the router's own protocol stack to the controller 220. This is not shown in the figures.

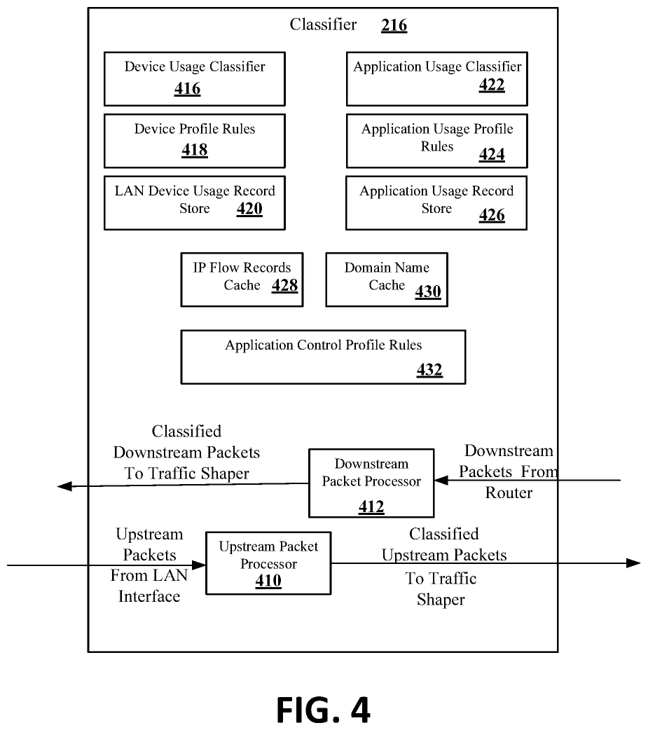

FIG. 4 illustrates a block diagram of a classifier 216 of the smart meter 122 introduced above. The classifier solves the technical problem of classifying network traffic flow by device and application as it flows through the CPE router. The technical solution of the classifier 216 includes various components and records to classify the network flow as described below. In some implementations, the classifier 216 maintains a collection of IP flow records with one record for each active IP flow. As used herein, an IP flow is the set of packets with the same source and destination IP addresses, protocol and source and destination ports. The classifier 216 uses finalized IP flow records to classify LAN devices and to total up per-device usage where the total per-device usage for a LAN device is the sum of the usage of all the records whose downstream IP address matches that of the LAN device. Alternatively, the total per-device usage for a LAN device is the sum of the usage of all the records whose downstream MAC address matches that of the LAN device. The classifier 216 further uses finalized IP flow records to classify that flow with an application name and to total per-application usage. The classifier also uses an in-progress IP flow record's attributes to quickly classify an in-progress IP flow IP flow with an application ID (which may shift over time) and to tag each packet with that application ID so that the Smart Meter Traffic Shaper may make the appropriate forward/drop decision.

Referring again to FIG. 4, the classifier 216 of the smart meter 122. The classifier 216 includes an upstream packet processor 410 and a downstream packet processor 412. The upstream packet processor 410 is responsible for processing upstream packets received from LAN devices via the LAN interface and sending classified upstream packets to the traffic shaper 218. The downstream packet processor 412 is responsible for processing downstream packets received from the router on their way to LAN devices via the LAN interface. The classifier 216 further includes a device usage classifier 416 which is responsible for processing IP flow records when they are finalized, that is, after they are no longer expected to have any further packets. The device usage classifier uses the finalized IP flow records to classify the type of each LAN device and to maintain each device's usage. The device usage classifier 416 uses device profile rules 418 to determine the type of each LAN device. The LAN device usage record store 420 maintains a record monitoring the usage of each LAN device and recording the type of device that has been determined by device classification and further assists with the classification of the LAN devices.

Referring again to FIG. 4, the classifier 216 further includes an application usage classifier 422 which is responsible for processing IP flow records when there are finalized, that is, after they are no longer expected to have any further packets in order to maintain usage by application. The application usage profile rules 424 are rules that the application usage classifier 422 uses to determine which application a finalized IP flow log record's usage should be attributed to. The application record usage store 426 maintains a record monitoring the usage of each classifiable application. The classifier 216 further includes a domain name cache 430 that stores the domain name to IP address translations of recently accessed hosts on the public internet. A given domain name may have translations to multiple different IP addresses. IP flow records cache 428 maintains an entry for each of the recent IP flows. The application control profile rules 432 include rules used by the upstream packet processor 410 and the downstream packet processor 412 to tag a packet with an application control classification.

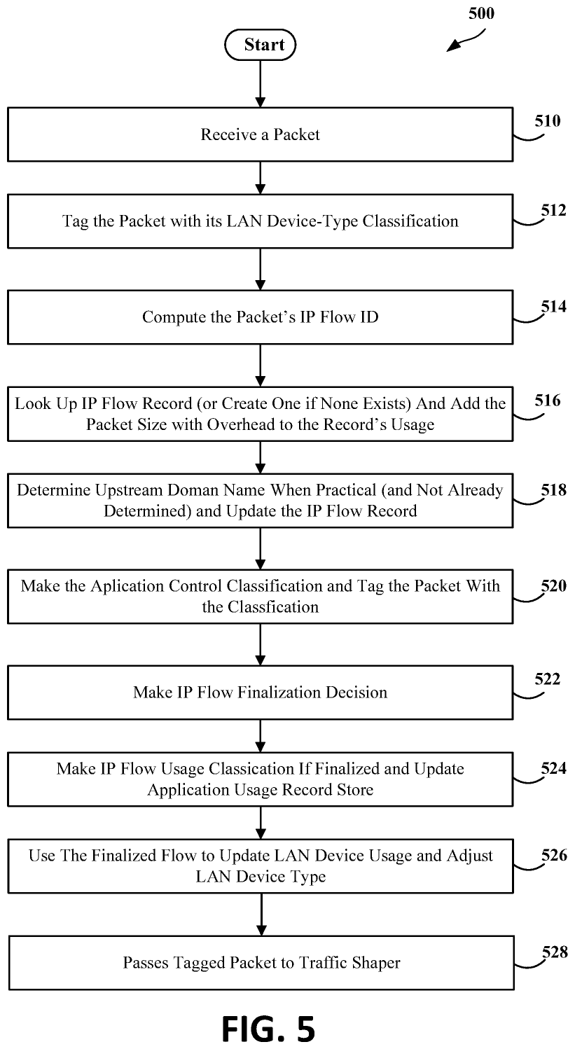

FIG. 5 illustrates a process or method flow 500 of steps for the classifier 216 to process upstream and downstream packets in the upstream packet processor 410 and the downstream packet processor 412, respectively. First, the classifier 216 receives a packet (step 510). For the upstream packet processor 410, the upstream packet is received from the LAN interface 210 and passed to the upstream packet processor 410 of the classifier 216. For the downstream packet processor 412, the downstream packet is received from the WAN interface 114 via the router. The router may perform network address translation/port translation (NAPT) on the packet, and then the packet is passed to the downstream packet processor 412. The remaining steps are similar for both the upstream packet processor 410 and the downstream packet processor 412, collectively referred to as packet processors. The packet processors look up the LAN device based on its downstream IP address or MAC address and tags the packet with the device's device-type classification (step 512). Next, the packet processors compute an IP flow identifier based on the packet's IP address, protocol and ports (step 514). The packet processors look up the IP flow in the IP Flow Record Cache using the IP flow identifier and, if none exists, creates a cache entry and adds the packet size along with any WAN overhead to the record's usage along (step 516). The processors attempt to determine the IP flow's upstream host domain name if the IP flow record does not already record a name and, upon determining the name, the classifier records that name in the record (step 518). The packet processors make or update an application control classification of the packet and tags the packet with the classification (step 520). The packet processors make an IP flow finalization decision (step 522). After finalizing an IP flow, a packet processor makes an IP flow classification to determine the flows application and updates that application's usage record in the application usage record store (step 524). Also, after finalizing an IP flow, a packet processor uses the finalized flow to update its LAN device's usage and to adjust its LAN device type (step 526). The packet processors pass the packet, tagged with its application control classification, to the traffic shaper (step 528).

Upstream Host Domain Name

The classifier 216, when practical, determines each IP flow's upstream host domain name, as the domain name is particularly useful for identifying devices and applications. The classifier 216 maintains a domain name cache 424 to facilitate this determination as introduced above with reference to FIG. 4. The determination of the IP flow's upstream host domain name may involve the following operations where all of them take place when handling just the first few packets of an IP flow. The classifier may examine DNS response packets from a downstream DNS IP flow and parsing a response with a standard query for a storing the domain name and address for each of the responses answers in the domain name cache. The classifier when processing a new IP flow, looks up the upstream IP address in the domain name cache and use that domain name on an unexpired cache hit. The classifier, when no cache hit was found, may examine the packets of an upstream HTTP IP flow by parsing the HTTP request header taking the domain name from the host field when it is present and storing domain name of IP address translation in the IP flow cache. The classifier uses the resulting domain name for both the HTTP connection's upstream and downstream IP flows. The classifier 216, when no unexpired cache hit was found, may then examine the packets of an upstream Transport Layer Security (TLS) IP flow by parsing the client hello message and taking the domain name from the server name field when it is present and storing the domain name from IP address translation in the IP flow cache. The classifier uses the resulting domain name for both the TLS connection's upstream and downstream IP flows. The classifier may then examine downstream packets of a TLS IP flow by parsing the Certificate when it is present and taking the domain name from the id-at-commonName field when it is present and storing Domain Name of IP address translation in the IP flow cache. The classifier uses the resulting domain name for both the TLS connection's upstream and downstream IP flows. The determination of domain name may be given up to save CPU after the first few packets of the IP flow have been parsed provided the IP flow is not handling DNS responses. When handling a DNS response IP flow, the downstream packet processor continues processing all downstream packets.

IP Flow Record

The classifier 216 may maintain IP flow records in the IP flow records cache 428 as introduced above. The IP flow records may include fields for each record as shown in Table 1. From the timestamps and the byte count, a thruput rate can be calculated. The classifier finalizes an IP flow record when it determines the flow has completed. For TCP IP flows this can be based on the processing of reset (RST) and finish (FIN) packets. For UDP and other IP flows this can also be based on idle timeout.

TABLE 1
IP Flow Record

The direction of the flow (upstream or downstream)
Upstream Domain Name (if it could be determined)
The upstream and downstream IP addresses
The upstream and downstream port numbers,
The LAN MAC address,
An IP flow start timestamp
A timestamp for the most recent packet
A packet counter
A count of the number of bytes of usage including an estimation
of any overhead the metered
ISP may impose on each packet and a histogram of packet sizes

Device Usage Classifier

The device usage classifier 416 maintains a cache of LAN device usage record store 420 with a record for each LAN device where a LAN device is identified by its MAC address. Alternatively, the LAN device could be identified by its IP address although a device's IP address may shift over time so the MAC address is preferable. The device usage classifier 416 processes finalized IP flow records to update that LAN device record and to classify that record's device. The device's usage recording is described further below. Device classification takes place by accumulating the information regarding the device over a recent period of time, e.g. 24 hours where the information is kept in buckets (e.g. 10 minute buckets) and when a bucket completes an old bucket of information is dropped to make room for a new bucket. The information of the LAN device records maintained by the device classifier 416 included in the buckets may include the server domain name of each of the server's visited, and the number of bytes of usage upstream and downstream.

Device classification is performed by periodically comparing the stats accumulated to the set of device profile rules 418 where the highest scoring of the matching rules becomes the device classification. The device profile rules 418 may be supplied by the controller 220 in FIG. 2. The comparisons are typically performed periodically, e.g. once a bucket accumulation period completes. A device profile rule is comprised of a set of attributes (see Table 2) and a set of match criteria (see Table 3) where the attributes are of use for classifying the device when the rule's match criteria match the device's stats.

TABLE 2
Device profile rule attributes.

| | |
|---|---|
| Base | The score that a matching rule has apart from any bonus |
| Score | score points for expected domain name matches |
| Device Type | Formatted text identifying the type of device that an |
| Name | end-user can use to help identify which of his devices |
| | matched the rule. Values might include: “WINDOWS PC”, |
| | “iPHONE”, “ROKU Video Player”, “SAMSUNG |
| | SmartTV”, “GOOGLE DOORBELL”, “ALEXA”, |
| | etc. Multiple device profile rules may have a given |
| | Device Type Name. When that is the case that Device |
| | Type Name's usage is totaled from the usage from |
| | each device profile rule with that Device Type Name. |
| Device Type | Formatted text describing the type of device and what is |
| Description | known about it from its matching this rule it in a fashion |
| | that an end-user can understand. |
| Device | A numerical value that provides the efficiency rating of this |
| Usage | device relative to other similar devices that provide similar |
| Efficiency | capabilities. |
| Rating | |
| Rule | Formatted text documentation explaining at a high-level the |
| Documenta- | match criteria and what about those match criteria cause the |
| tion | specific device type to be identify. |

A device profile rule includes a combination of one or more of the match criteria shown in Table 3. All of a rule's match criteria must match for the rule as a whole to match.

TABLE 3
Device Profile Match Criteria

| | |
|---|---|
| Minimum | If the minimum is not reached the rule does not match |
| number of | the device. |
| different | |
| domains | |
| visited | |
| Maximum | If the maximum is exceeded the rule does not match |
| number of | the device. |
| different | |
| domains | |
| visited | |
| Mandatory | Where failure to have connected to any of the names in |
| domain | the list cause the rule not to match the device. |
| name | NOTE: A wild-card domain name optionally begins with |
| wild-card | an ‘*’ character indicating that any set of |
| list | characters preceding what follows the * is considered |
| | to match this wild-carded domain name. |
| Expected | Holds a list of optionally wild-carded domain names |
| domain | where each such name has a bonus score. Each expected |
| name | domain match increases the rule's score by its |
| wild-card | bonus score. |
| list | |
| Unexpected | A match of any of these names causes the rule to be |
| domain | considered to not match the device. |
| name | |
| wild-card | |
| list | |
| Minimum | If the minimum is not reached the rule does not match |
| daily usage | the device. |
| Maximum | If the maximum is exceeded the rule does not match |
| daily usage | the device. |
| Minimum | The percentage of the device's usage that is downstream |
| downstream | where if the minimum is not reached the rule does not |
| usage percent | match the device. |
| Maximum | The percentage of the device's usage that is downstream |
| downstream | where if the maximum is exceeded the rule does not |
| usage percent | match the device. |
| Minimum | The percentage of the device's usage that is from VPN IP |
| VPN usage | flows where if the minimum is not reached the rule does |
| percent | not |
| | match the device. |
| Maximum | The percentage of the device's that is from VPN IP flows |
| VPN usage | where if the maximum is exceeded the rule does not |
| percent | match the device. |

Application Usage Classifier

The application usage classifier 412 maintains a collection of application usage profile rules 424 where the collection of application profile rules is used to determine to which application an IP flow's usage should attributed to. The application usage profile rules 424 in some implementations may be supplied by the controller 220. The application usage classifier 412 may also maintain a collection of application usage objects with one such usage object for each application profile. The application usage classifier 412 processes finalized IP flow records to determine which application the IP flow's traffic should be attributed to and to update that application's recorded usage. The application usage classifier 412 compares a finalized IP flow record with each of the application usage profile rules 424 where the highest scoring of the matching rules becomes the application classification for that flow and where the flow's usage is attributed to that application and stored in the application usage record store 426. An application usage profile rule 424 may have attributes as shown in Table 4.

TABLE 4
Application Usage Profile Rule Attributes

| | |
|---|---|
| Score | A numerical score for this rule when it matches an IP flow. |
| Application | Text identifying the application in a way that an end-user |
| Name | can use understand which applications are consuming his |
| | metered bandwidth. Multiple rules may have a given |
| | Application Name. When that is the case that Application |
| | Name's usage is totaled from the usage from each rule |
| | with that Application Name. |
| Application | Text identifying a set of similar applications. For example, |
| Group Name | StreamingVideo might be the group streaming video |
| | services. This field allows an overview of usage by |
| | application group to be available. |
| Application | Formatted text describing the application and what is |
| Description | known about it in a fashion that an end-user can understand. |
| Application | A numerical value that provides the efficiency rating of this |
| Usage | application relative to other similar applications that provide |
| Efficiency | similar capabilities. |
| Rating | |
| Rule | Formatted text documentation explaining at a high-level the |
| Documenta- | match criteria and what about those match criteria cause the |
| tion | specific device type to be identify. |

An application usage profile rule 424 includes a combination of one or more of the match criteria listed in Table 5, where all of a rule's match criteria must match for the rule as a whole to match.

TABLE 5
Application Usage Profile Rule Matching Criteria

| | |
|---|---|
| Upstream | Holds a list of optionally wild-carded domain names where |
| domain | each such name has a bonus score. Each expected domain |
| name | match increases the rule's score by its bonus score. |
| wild-card | |
| list | |
| Protocol | One of: UDP, TCP, ICMP, HTTP, HTTPS, DNS, etc. |
| Upstream | A match takes place when the upstream port (for example |
| Port | the port number of the server in the Public Internet) |
| Number | matches any of these port numbers. |
| List | |
| Downstream | A match takes place when the downstream port, that is, the |
| Port | port number of the host on the LAN, matches any of these |
| Number | port numbers. |
| List | |
| Download | A match takes place when the number of downstream bytes |
| Size | falls within this range. This is useful for distinguishing |
| Range | between bulk transfers and interactive data. |
| Upload | A match takes place when the number of upstream bytes |
| Size | falls within this range. This is useful for distinguishing |
| Range | between bulk transfers and interactive data. |
| Recency | This field has a domain name and a duration in seconds. |
| upstream | An IP flow matches when its device had an IP flow |
| domain | matching the domain name as recently as the duration |
| name | in seconds. This field, together with protocol and |
| wild-cast | perhaps upstream port number match criteria provides |
| list | a way of identifying applications which start by |
| | visiting a known domain name and continue by using |
| | an IP flow where the domain name cannot be determined |
| | of the matching protocol and optionally upstream port |
| | number. A Zoom ™ meeting is an example of such |
| | an application. |

Application Control Classification

The packet processors 410, 412 in FIG. 4 maintain a collection of application control profile rules 432. The application control profiles rules 432 may be used to determine to which application an IP flow's usage should be attributed to. The application control profile rules 432 in some implementations may be supplied by the controller 220. The packet processors 410, 412 operate on each packet tagging the packet with an Application ID. It is important to allow the traffic shaper 218 to effectively control applications to determine as soon in the life of an IP flow that flow's application. To accomplish this, the packet processors pick an IP flow's application tag when either the upstream domain name has been determined or when it is determined that the upstream domain name cannot be determined. When that occurs the packet processor compares an IP flow record with each of the application control profile rules where the highest scoring of the matching rules has its application ID tagged to the packet.

An application control profile rule 432 has the same attributes as an application usage rule profile rule 424 as shown in Table 4. It also has a numeric application ID that is tagged to each of an IP flow's packets thereby facilitating the traffic shaper's 218 determination of the IP flow's application. An application control profile rule 432 includes a set of match criteria (for example a subset of the rule matching criteria listed in Table 5) where all of a rule's match criteria must match for the rule as a whole to match. In an implementation, the match criteria includes: upstream domain name wild-card list, protocol, upstream port number list, and downstream port number list.

Traffic Shaper

The traffic shaper 218 receives device and application control settings from the controller 220 and enforces those control settings on IP packets as it relays those packets between the LAN interface 210 and the router block 212 (FIG. 2). The traffic shaper 218 uses the control settings and associated actions shown in Table 6 to control network traffic for an individual device-type, specific LAN device (as identified by MAC or IP address) or application. The traffic shaper 218 solves the technical problem of controlling network bandwidth over a metered IP 120. The traffic shaper provides the technical solution of forwarding or dropping packets depending on application control settings controlled by the end-user.

TABLE 6
Application Centre Settings.

| | |
|---|---|
| Blocked | All of a matching IP flow's packets are dropped as long as |
| | the setting is in place. |
| Timed | All of a matching IP flow's packets are dropped for |
| Block | configurable ranges of time where all of a matching IP |
| | flows packets are dropped during those times. An example |
| | might be to block a specific gaming device during |
| | homework hours or to block big gaming downloads except |
| | during non-busy times where an ISP does not meter traffic. |
| Usage | A matching IP flow's packets are blocked after the device- |
| Limit | type, specific LAN device or application has consumed a |
| | specified amount of usage in a specified period of time (e.g. |
| | day, week, etc.). |
| Downstream | A random-early drop type algorithm is used to enforce a |
| Rate Limit | rate limit. |
| Upstream | A random-early drop type algorithm is used to enforce a |
| Rate Limit | rate limit. |
| Timed | A random-early drop type algorithm is used to enforce a |
| Downstream | rate limit for configurable ranges of time. |
| Rate Limit | |
| Timed | A random-early drop type algorithm is used to enforce a |
| Upstream | rate limit for configurable ranges of time. |
| Rate Limit | |

Controller

The controller 220 obtains traffic shaper control settings 126 to control operation of the traffic shaper 218. In some implementations, the control settings 126 are stored in the smart meter service 124 and are made available to the controller 220 when the control settings 126 change. This ensures that settings are not lost should the CPE router 110 have to be replaced. Alternatively, the control settings 126 could be stored in the controller 220 where the smart meter service 124 provides a conduit for the smart meter application 128 to view and modify those settings. In some implementations, usage data (provided by device, application, hour of the day, etc.) may be periodically passed to the smart meter service 124, which makes the data available to the smart meter application 128. The smart meter service may be able to adjust the frequency at which usage data is made available to the smart meter application 128.

Smart Meter Service

The smart meter service 124 may interact with multiple smart meters and controllers associated with different users. The smart meter application may allow an individual user to view and understand the individual user's network usage. The usage data is displayed in a fashion that helps the user understand what devices, applications and time of day are dominating the user's overall usage. Further, the smart meter service 124 together with the smart meter application (FIG. 1, 128) may recommend for purchase to the user applications and devices with lower usage than what the user is currently using. When providing such a recommendation the smart meter service 124 together with the smart meter application 128 may provide information that qualitatively and quantitatively estimates the improvement expected from switching to the alternative. This could be by providing the usage efficiency ratings of the before and after alternatives. It could also be in the form of a GB usage savings, percent of monthly limit usage savings or even monthly cost improvement that could be based on a calculation of the relative efficiency of the two devices, the usage of the original device and optionally information about the cost structure of end-user's metered ISP. The smart meter service 124 may interact with a control devices or application to allow the user to manage usage. For example, the smart meter service may interact with the smart meter application 128 running in a cell phone 130 shown in FIG. 1, or a similar device where the smart meter application 128 provides to the user a user interface to monitor and manage network usage. The smart meter service 124 handles the authentication of users (account and password and similar authentication mechanism) to ensure that a site's settings and usage are only available to authorized users.

In some implementations, the smart meter service 124 may maintain a database of usage for each site and a data base of control settings for each site which is synchronized with each site's operation. The smart meter service 124 may further maintain a recommendations database 132 with a set of alternative applications and devices where the alternative devices and applications have information about their relative usage of network resources. The smart meter service may evaluate a site's current device type and application usage and use the current device type and application usage to lookup a recommended alternative to a reported device type or application. The smart meter service 124 operates as an internet store front that facilitates the purchase or adoption of recommended alternative devices and applications. For example, where the smart determines that an application that uses a high amount of network resources it may consult the recommendations database 132 at the smart meter service 124 for alternative applications that are more efficient and optimized to use metered ISPs. The smart meter service 124 may present an alternative to the end-user with benefits of the alternative shown in terms of the amount of bandwidth savings or fraction of a metered WAN's usage limit that is saved or even the amount of money saved when the ISP's price structure is known. For example, the user interface may determine that a “example” application uses an exorbitant amount of network resources and offer the user to purchase an alternate application that is more efficient in its bandwidth use. For example, a video doorbell device or application may constantly upload photos to a web service that determines whether any activity is taking place. Such a doorbell's usage would be marked as exorbitant by the smart meter. The recommended alternative in the recommendations database would be a video doorbell with local processing that only uploads information to the Internet when the local processing indicates that something significant (like a person standing at the door) occurs. The recommended alternative could be shown to save a percentage of the bandwidth over the current application such as 50%, or save a fraction of the usage limit such as 2 percent of the user's monthly limit. The local processing drastically reduces the internet usage and thus becomes an alternative to be recommended. The smart meter service also provides a web interface 222 allowing an end-user to use a web browser, in addition to or instead the smart meter application 128, to interact with the smart meter service 124.

Smart Meter App

The smart meter application 128 may be an application running on a cell-phone, tablet, etc. that provides a user interface to the system 100 which includes the CPE router 110 with the smart meter 122. The combination of the Smart Meter service (124) with the Smart Meter application (128) allows an end-user to evaluate usage even when not connected to the user's local area network. The user interface may allow the user to have multiple views of a site's usage. For example, the user interface may show the heaviest usage by a device or application and then allow a user to drill down from a top-level view to see to usage by individual devices or individual applications (on all devices) and their usage over time. The user interface may also show usage of“applications per device” where the usage of each application on a particular device is shown. The smart meter application 128 may further allow the user to setup control settings for devices, device-types and applications. Further, the user interface of the smart meter application 128 may communicate with the smart meter service to provide the user with recommended alternatives to the devices and applications they are currently using as described above. The smart meter application 128 may also allow access to an internet storefront for purchasing those alternatives devices and applications.

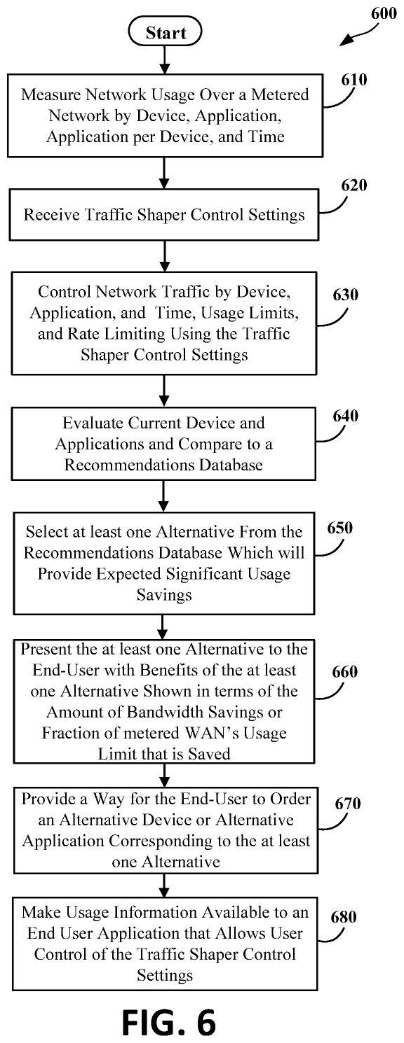

FIG. 6 is a flow diagram of a process or method 600 for monitoring and controlling internet usage in accordance with this disclosure. Operations in the example method 600 could be performed various entities in system 100. This is only for purposes of example and is not intended as a limitation regarding implementations and practices in accordance with this disclosure. First, the system measures network usage over a metered network by device, application, application per device and time (step 610). Next, receive traffic shaper control settings (step 620). Then, control network traffic by device and application, blocking time, usage limits, and rate limiting using traffic shaper control settings (step 630). Next, evaluate current devices and applications and compare to a recommendations database with alternatives for the devices and applications (step 640). Next, select at least one alternative from the recommendations database which will provide expected significant usage savings (step 650). Then, present the at least one alternative to the end-user with benefits of the at least one alternative shown in terms of the amount of bandwidth savings or fraction of a metered WAN's usage limit that is saved (step 660). Then provide a way for the end-user to order an alternative device or alternative application corresponding to the at least one alternative (step 670). The way provided for the end-user to order the device or application could include providing a link to an online retailer to purchase the recommended device or application. Then make the usage information available to an end-user application that allows user control of the traffic shaper control settings (step 680).

FIG. 7A illustrates a high-level block diagram of a system 700A for monitoring and controlling internet usage. The system 700 illustrates some alternative implementations of the system 100 described above. Similar entities to those described with reference to system 100 have the same names and reference designators as those described above. In one alternative implementation, the WAN modem 118 may be integrated into and within the CPE router 110. In another alternative implementation, the functionality described above for the smart meter service 124 may be incorporated into the CPE Router 110 as smart meter service 704. Smart meter service 704 could allow web browsers and the smart meter application to access the smart meter service information and control settings described above directly from the LAN or potentially from the public internet. Another alternative implementation could move the smart meter 122 with the controller, traffic shaper and classifier into a device within an ISP such as metered ISP 120 thru which all traffic flows to a user.

FIG. 7B illustrates a high-level block diagram of a system 700B for monitoring and controlling internet usage with another alternative implementations of the system 100 described above. In this alternative implementation, the CPE Router 110 as described herein is a software defined (SD) WAN router that includes multiple WAN interfaces to multiple WAN modems 118 connecting the CPE router 110 to the internet 116 over one or more metered IPSs 120. In this implementation, usage monitoring may be provided on a per-WAN basis, and the SD-WAN configuration may be adjusted to have applications and devices prefer one WAN over another. The smart meter tracks usage for all network traffic including network traffic to WAN network connection by application, device, application per device, time of day, etc. The smart meter further allows the user to control traffic shaping as described above in addition to controlling usage per individual WAN including selecting which device application will use which WAN by time of day etc.

FIG. 7C illustrates a high-level block diagram of a system 700C for monitoring and controlling internet usage. The system 700C illustrates an additional alternative implementation of the system 100 described above. Similar entities to those described with reference to system 100 have the same names and reference designators as those described above. In this implementation, the smart meter 122 may be integrated and operate within a WIFI wireless access point device 702 that resides on the path from the LAN to the Metered ISP through a CPE router 110.

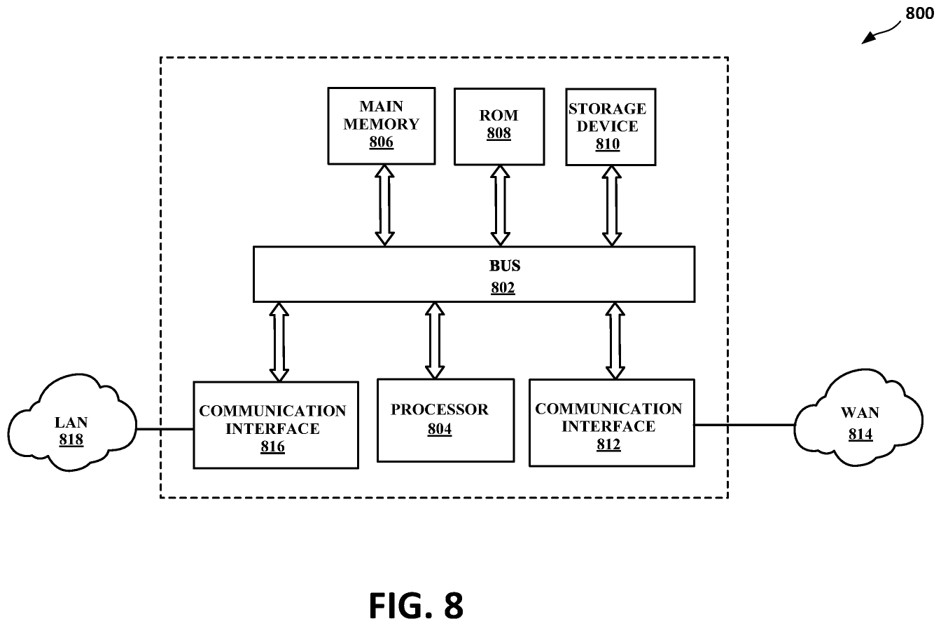

FIG. 8 is a block diagram showing an example of router hardware 800 upon which aspects of this disclosure may be implemented. It will be understood that functional blocks illustrated in FIG. 8 are logical blocks of a hardware router such as a CPE router described in the functional block diagram of FIG. 2, and do not necessarily correspond to particular hardware. The router 800 may include a bus 802 or other communication mechanism for communicating information, and a processor 804 coupled with the bus 902 for processing information. The router 800 may also include a main memory 806, such as a random-access memory (RAM) or other dynamic storage device, coupled to the bus 802 for storing information and executable instructions to be executed by the processor 804. The executable instructions can include instruction that, when executed by the processor 804, cause the processor to perform operations in accordance with the flow diagrams and functionality described above. The main memory 806 may also be used for storing temporary variables or other intermediate information during execution of instructions to be executed by the processor 804.

The router 800 may further include a read only memory (ROM) 808 or other static storage device coupled to the bus 802 for storing static information and instructions for the processor 804. A storage device 810, such as a flash or other non-volatile memory may be coupled to the bus 802 for storing information and instructions. The router 800 may also include a communication interface 812 coupled to a bus for two-way data communication coupling to a WAN 814 to provide data communication through one or more networks to other data devices. The router 800 may also include another communication interface 816 coupled to a bus for two-way data communication coupling to a LAN 818 to provide data communication through the LAN to other data devices such as LAN hosts 112 shown in FIG. 1.

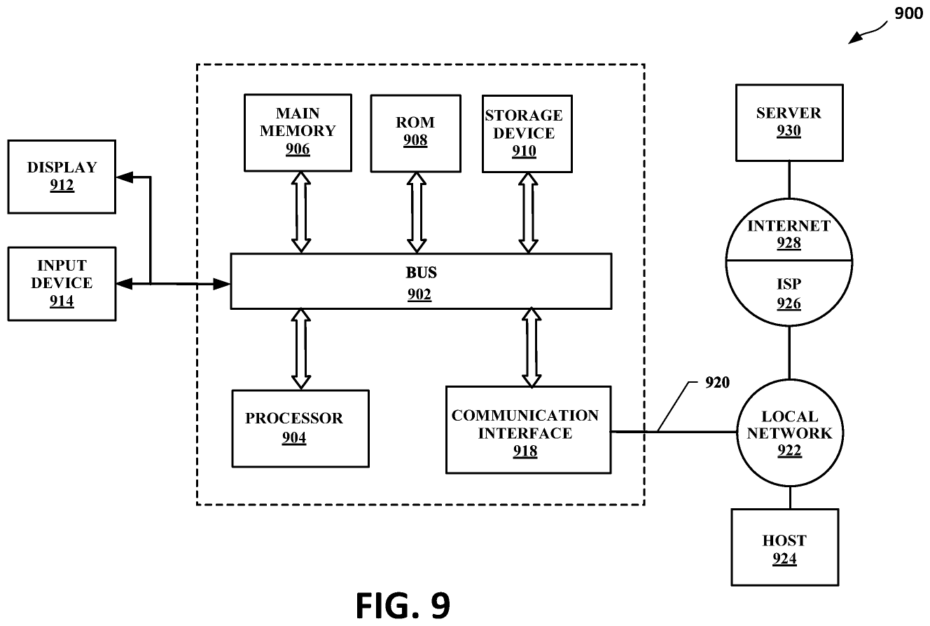

FIG. 9 is a block diagram showing an example a computer system 900 upon which aspects of this disclosure may be implemented. It will be understood that functional blocks illustrated in FIG. 9 are logical blocks, and do not necessarily correspond to particular hardware.

The computer system 900 may include a bus 902 or other communication mechanism for communicating information, and a processor 904 coupled with the bus 902 for processing information. The computer system 900 may also include a main memory 906, such as a random-access memory (RAM) or other dynamic storage device, coupled to the bus 902 for storing information and executable instructions to be executed by the processor 904. The executable instructions can include instruction that, when executed by the processor 904, cause the processor to perform operations in accordance with the flow diagram of FIG. 8. The main memory 906 may also be used for storing temporary variables or other intermediate information during execution of instructions to be executed by the processor 904. The computer system 900 may implement, for example, UT, SRAN, AMF, UPF, etc.

The computer system 900 may further include a read only memory (ROM) 908 or other static storage device coupled to the bus 902 for storing static information and instructions for the processor 904. A storage device 910, such as a flash or other non-volatile memory may be coupled to the bus 902 for storing information and instructions.

The computer system 900 may be coupled via the bus 902 to a display 912, such as a liquid crystal display (LCD), for displaying information. One or more user input devices, such as the example user input device 914 may be coupled to the bus 902, and may be configured for receiving various user inputs, such as user command selections and communicating these to the processor 904, or to the main memory 906. The user input device 914 may include physical structure, or virtual implementation, or both, providing user input modes or options, for controlling, for example, a cursor, visible to a user through display 912 or through other techniques, and such modes or operations may include, for example virtual mouse, trackball, or cursor direction keys.

The computer system 900 may include respective resources of the processor 904 executing, in an overlapping or interleaved manner, respective program instructions. Instructions may be read into the main memory 906 from another machine-readable medium, such as the storage device 910. In some examples, hard-wired circuitry may be used in place of or in combination with software instructions. The term “machine-readable medium” as used herein refers to any medium that participates in providing data that causes a machine to operate in a specific fashion. Such a medium may take forms, including but not limited to, non-volatile media, volatile media, and transmission media. Non-volatile media may include, for example, optical or magnetic disks, such as storage device 910. Transmission media may include optical paths, or electrical or acoustic signal propagation paths, and may include acoustic or light waves, such as those generated during radio-wave and infra-red data communications, that are capable of carrying instructions detectable by a physical mechanism for input to a machine.

The computer system 900 may also include a communication interface 918 coupled to the bus 902, for two-way data communication coupling to a network link 920 connected to a local network 922. The network link 920 may provide data communication through one or more networks to other data devices. For example, the network link 920 may provide a connection through the local network 922 to a host computer 924 or to data equipment operated by an Internet Service Provider (ISP) 926 to access through the Internet 928 a server 930, for example, to obtain code for an application program.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

What is claimed is:

1. A method for metering network usage and recommended alternatives for reducing usage, comprising:
measuring network usage of network traffic through a customer premise equipment (CPE) router over a metered network by device and application;
receive traffic shaper control settings;
controlling network traffic usage by device and application according to the traffic shaper control settings;
evaluating current devices and current applications and comparing to a recommendations database with alternatives for devices and applications;
selecting at least one alternative from the recommendations database which will provide expected significant usage savings;
presenting the at least one alternative to the end-user with benefits of the at least one alternative shown in terms of the amount of bandwidth savings or fraction of a metered WAN's usage limit that is saved; and
providing a way for the end-user to order an alternative device or alternative application corresponding to the at least one alternative.

2. A method according to claim 1, wherein measuring network usage of network traffic through a customer premise equipment (CPE) router over a metered network further comprises measuring by application per device and time, and wherein controlling network traffic usage further comprises controlling network usage by time according to the traffic shaper control settings.

3. A method for metering network usage, comprising:
measuring network usage of network traffic through a customer premise equipment (CPE) router over a metered network by device, application, application per device and time;
receive traffic shaper control setting; and
control network traffic usage by device, application and time according to the traffic shaper control settings.

4. A method according to claim 3, further comprising making usage information available to an end-user application that allows an end-user to control the traffic shaper control settings.

5. A method according to claim 3, further comprising:
evaluating current devices and current applications and comparing to a recommendations database with alternatives for devices and applications;
selecting at least one alternative from the recommendations database which will provide expected significant usage savings; and
presenting the at least one alternative to an end-user with benefits of the alternative shown in terms of the amount of bandwidth savings or fraction of a metered WAN's usage limit that is saved.

6. A method according to claim 5, wherein the end-user application further provides a way for the end-user to order an alternative device or an alternative application corresponding to the at least one alternative.

7. A method according to claim 5, wherein the end-user application is an application executing on a cell phone.

8. A method according to claim 3, wherein at least one device is given an end-user identifiable device type name based on characteristics of network traffic carried by the at least one device and that is partially based on upstream domain names the at least one device has communicated with.

9. A method according to claim 3, wherein controlling network traffic by device application and time according to the traffic share control setting further comprises blocking network traffic, blocking network traffic by time of day, blocking network traffic when usage limits are reached, rate limiting total network traffic and rate limiting network traffic by time of day.

10. A network metering system comprising:
a classifier which measures network usage by device, application, and time of day, where at least one device is given an end-user identifiable device type name based on characteristics of network traffic the at least one device carried, and at least in part based on upstream domain names the at least one device has interacted with; and
a traffic shaper that allows device network traffic and application network traffic to be individually controlled with control settings.

11. A network metering system of claim 10, further comprising a smart meter application configured to make available to an end-user usage information over time by device and application.

12. A network metering system of claim 11, wherein the smart meter application allows a user to control the control settings, where the control setting include blocking, blocking by time of day, blocking when usage limits are reached, rate limiting and rate limiting by time of day.

13. A network metering system of claim 11, wherein the smart meter application evaluates current devices and current applications, uses a recommendations database with alternatives for devices and applications to select at least one alternative from the recommendations database which will provide expected significant usage savings; and
presents the at least one alternative to an end-user with benefits of the alternative shown in terms of the amount of bandwidth savings or fraction of a metered WAN's usage limit that is saved.

14. A network metering system of claim 10 wherein the control settings include blocking, blocking by time of day, blocking when usage limits are reached, rate limiting and rate limiting by time of day.

15. A network metering system of claim 10, wherein the classifier and the traffic shaper are implemented in a smart meter on a customer premise router.

16. A network metering system of claim 10, wherein the classifier comprises an application usage classifier with application usage profile rules, where the application usage classifier processes IP flow records to maintain usage by application according to the application usage profile rules used to determine which application network usage should be attributed to.

17. A network metering system of claim 10, wherein the classifier comprises a device usage classifier with device profile rules, where the device usage classifier processes IP flow records to classify a type of each LAN device and to maintain a usage for each device, and where the device profile rules determine the type of each LAN device.

18. A network metering system of claim 10, wherein the classifier comprises an IP flow records cache with a record entry for each recent IP flow.

19. A network metering system of claim 10, wherein the classifier comprises a domain name cache that stores a domain name to IP address translations of recently accessed hosts on a public internet.

20. A network metering system of claim 10, wherein the classifier comprises application control profile rules which are used to determine to which application an IP flow's usage should be attributed to.
